(19) United States
(12) Patent Application Publication
(10) Pub. No.: US 2025/0335533 A1
(43) Pub. Date: Oct. 30, 2025

(54) Systems and methods for generating and displaying webpages

(71) Applicant: Canva Pty Ltd, Surry Hills (AU)

(72) Inventor: Duncan Antony Ernest CLARK, London (GB)

(73) Assignee: Canva Pty Ltd, Surry Hills (AU)

(21) Appl. No.: 19/191,247

(22) Filed: Apr. 28, 2025

(30) Foreign Application Priority Data
Apr. 30, 2024 (AU) 2024202807

(51) Int. Cl. G06F 16/958

(52) U.S. Cl. CPC G06F 16/986; G06F 16/972

(57) ABSTRACT

Described herein is a computer implemented method. The method includes receiving main webpage data that defines a main webpage and includes a subpage script. Processing the subpage script includes retrieving subpage data defining first and second background items and first and second foreground items, updating the main webpage to include a subpage container in a subpage section of the main webpage, including the first and second background items in the subpage container, and including first and second foreground element that correspond to the first and second foreground items in the main webpage. The main webpage is further updated to include a tracking mechanism that is configured to track movement of the first and second foreground elements and the main webpage is displayed on a display.

### CROSS-REFERENCE TO RELATED APPLICATION

This application is a U.S. Non-Provisional Application that claims priority to Australian Patent Application No. 2024202807, filed Apr. 30, 2024, which is hereby incorporated by reference in its entirety.

### FIELD

The present disclosure is directed to systems and methods for generating and displaying webpages.

### BACKGROUND

Webpages serve as a ubiquitous medium for the dissemination of information, offering a platform that combines both textual and visual elements to present information effectively.

Traditionally, webpages have been designed to display text and visual elements such as photos and charts in a static manner. As the user scrolls through a webpage, these elements maintain a fixed order and appearance.

A more recent webpage approach, known as scrollytelling, enhances the interactive experience of web users. Scrollytelling is a form of online storytelling that exhibits dynamic behaviour as the page is scrolled. Unlike conventional webpages where the visual elements simply scroll with the text, scrollytelling introduces a mechanism where certain visual elements become temporarily fixed at a specific position on the screen.

Background information described in this specification is background information known to the inventors. Reference to this information as background information is not an acknowledgment or suggestion that this background information is prior art or is common general knowledge to a person of ordinary skill in the art.

### SUMMARY

In one embodiment, the present disclosure provides a computer implemented method including: receiving main webpage data defining a main webpage, wherein the main webpage data includes a subpage script; processing the subpage script, wherein processing the subpage script includes: retrieving subpage data that defines a first background item, a second background item, a first foreground item, and a second foreground item; updating the main webpage to include a subpage container, wherein the subpage container is included in a subpage section of the main webpage; including the first background item and the second background item in the subpage container; generating, based on the first and second foreground items, first and second foreground elements; updating the main webpage so that the first and second foreground elements are included in the subpage section but not the subpage container; and updating the main webpage to include a tracking mechanism that is configured to track movement of the first and second foreground elements; and displaying the main webpage on a display.

### BRIEF DESCRIPTION OF THE DRAWINGS

Preferred embodiments of the invention will be described, by way of examples only, with reference to the accompanying representations, wherein:

FIG. 1 is a diagram depicting a networked environment in which various features of the present disclosure may be implemented.

FIG. 2 is a block diagram of a computer processing system configurable to perform various features of the present disclosure.

FIG. 3 is a flowchart depicting operations performed to generate a subpage.

FIG. 4 is a flowchart depicting operations performed to generate a main webpage.

FIG. 5 is a flowchart depicting operations performed to retrieve and render a main webpage.

FIG. 6 depicts a logical view of a main webpage prior to being updated in accordance with embodiments of the present disclosure.

FIG. 7 depicts a logical view of a main webpage after being updated in accordance with embodiments of the present disclosure.

FIG. 8 is a flowchart depicting operations performed to navigate an updated webpage.

FIGS. 9-14 depict an example client application enabling the navigation of an updated webpage.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present disclosure as defined by the appended claims.

### DETAILED DESCRIPTION OF THE EMBODIMENTS

In the following description numerous specific details are set forth in order to provide a thorough understanding of the present disclosure. It will be apparent, however, that the present disclosure may be practiced without these specific details. In some instances, well-known structures and devices are shown in block diagram form in order to avoid unnecessary obscuring.

Scrollytelling is a method of configuring a webpage to present information and can be integrated into more traditionally structured webpages or websites. For example, a webpage may optionally feature traditionally configured elements (e.g., text, photos, and charts) that respond to the scrolling of the webpage in a standard, static manner. It is possible to include additional content within the same webpage to provide a scrollytelling experience. Such content may be, for example, one or more background elements each of which is associated with one or more foreground elements. The scrollytelling experience may be configured such that, as the user scrolls, the background elements become fixed in certain positions on the screen and foreground elements passing over the background elements, creating a juxtaposition between a foreground element (which is moving) and a background element (which is stationary).

Skilled website developers can create a scrollytelling type website by, for example, using a combination of HyperText Markup Language (HTML) and JavaScript. The creation of effective scrollytelling type websites can, however, prove difficult—or even out of reach—for less technical users.

To illustrate this, one technique that can be considered for use in creating a scrollytelling type website is to use an iframe to host the elements associated with the scrollytelling experience (e.g., the background and foreground elements). Without careful and appropriate configuration, however, the use of an iframe will not produce a satisfactory user experience.

For example, web browsers do not seamlessly pass page scroll handling between a parent webpage and an iframe embedded within the parent webpage. Consequently, when scrolling the parent webpage quickly, the embedded scrollytelling section could be skipped entirely, with the scroll handling never being transferred from the parent webpage to the iframe.

As another example, in the event the scroll handling is successfully transferred from a parent webpage to an embedded iframe, often this transfer of control happens before the iframe fills the viewport. This can result, for example, in the scrollytelling content not being correctly vertically aligned on the page.

As another example, foreground elements (e.g., floating captions) associated with the scrollytelling content are typically not affected by the parent webpage's Cascading Style Sheets (CSS) code associated with the parent webpage. This makes it infeasible for such foreground elements to inherit fonts and styling properties from the parent webpage which, in turn, can result in the foreground elements not matching the styles of the parent webpage and therefore not looking as if they are part of the parent webpage.

This disclosure is directed to systems and methods for producing and navigating webpages containing scrollytelling content.

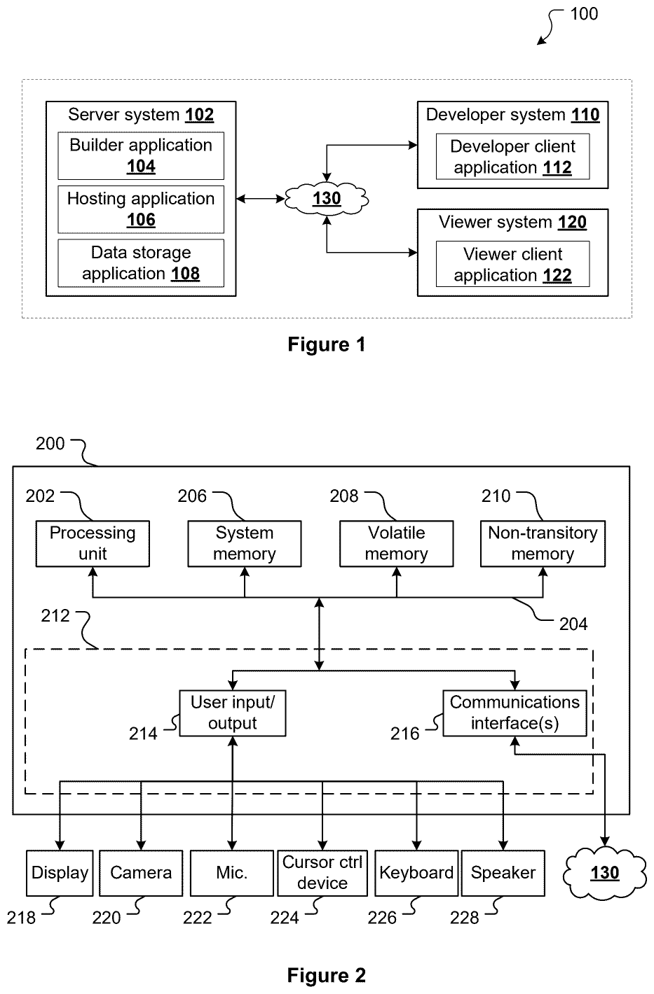

FIG. 1 is a diagram depicting a networked environment 100 in which various features of the present disclosure may be implemented.

Networked environment 100 includes a server system 102 and two client systems (referred to as the developer system 110 and viewer system 120) which communicate via one or more communications networks 130 (e.g. the Internet).

Generally speaking, the server system 102 includes computer processing hardware (e.g. one or more computer processing systems such as system 200 discussed below) on which applications that provide server-side functionality to client applications such as developer client application 112 and viewer client application 122 (described below) execute. In the present example, server system 102 includes what will be referred to as a builder application 104, a hosting application 106, and a data storage application 108.

In the present embodiment, the builder application 104 and the hosting application 106 execute to provide client application endpoints accessible over communications network 130. In the present example the builder and hosting application 104 and 106 serve web browser client applications and, accordingly, are web server applications which receive and respond (for example) to HTTP requests. In alternative embodiments, the builder applications 106 may serve a native client application (e.g. developer application 112), in which case it will be an application server configured to receive, process, and respond to specifically defined API calls received from such a client application.

In the present example, the builder application 104 (and/or other applications of server system 102) facilitates various functions related to building and modifying webpages according to the embodiments of the present disclosure. These may include, for example, webpage creation, editing, storage, organisation, searching, retrieval, viewing, sharing, publishing, and/or other functions related to webpage editing and publication.

In the present example, the hosting application 106 (and/or other applications of server system 102) facilitates various functions related to hosting webpages according to the embodiments of the present disclosure. These may include, for example, webpage storage, organisation, searching, retrieval, viewing, sharing, publishing, and/or other functions related to webpage hosting.

The builder application 104 and the hosting application 106 (and/or other applications) may also facilitate additional, related functions such as user account creation and management, user group creation and management, user and user group permission management, user authentication, and/or other server-side functions.

In the present example, the data storage application 108 executes to receive and process requests to persistently store and retrieve data relevant to the operations performed/services provided by the server system 102. Such requests may be received from the builder application 104, the hosting application 106, and/or other server system applications. Data relevant to the operations performed/services provided by the server system 102 may include, for example, user account data, webpage data (i.e. data describing webpages that have been created by users), and/or other data relevant to the operation of the server system 102.

The data storage application 108 may, for example, be a relational database management application or an alternative application for storing and retrieving data from one or more data storage devices (e.g. one or more non-transitory computer readable storage devices such as hard disks, solid state drives, tape drives, or alternative computer readable storage devices, not shown).

In the present example, networked environment 100 includes two different types of client systems. These will be referred to as the developer system 110 (which hosts/executes what will be referred to as a developer client application 112, or developer application 112 for short) and the viewer system 120 (which hosts/executes a viewer client application 122 or viewer application 122 for short).

The developer and viewer applications 112 and 122 are executed by their respective systems 110 and 120 to configure those systems to provide client-side functionality to applications of the server system 102. Via the client applications, and as discussed in detail below, users can access the various techniques described herein.

The developer and viewer applications 112 and 122 may, for example, each be a general web browser application which accesses the relevant server application (e.g. 104 106) via an appropriate uniform resource locator (URL) and communicates with the server applications via general world-wide-web protocols (e.g. http, https, ftp).

The present disclosure describes various operations that are performed by applications of the server system 102 and client applications 112 and 122. In many instances, however, operations described as being performed by a particular application (e.g. builder application 104) could be performed by (or in conjunction with) one or more alternative applications, and/or operations described as being performed by multiple separate applications could in some instances be performed by a single application.

The techniques and operations described herein are performed by one or more computer processing systems.

By way of example, the client systems (e.g. developer system 110 and viewer system 120) may each be any computer processing system which is configured (or configurable) by hardware and/or software—e.g. the developer and viewer client applications 112 and 122—to offer client-side functionality. Such a system may be a desktop computer, laptop computer, tablet computing device, mobile/smart phone, or other appropriate computer processing system.

Similarly, the applications of server system 102 are also executed by one or more computer processing systems. Server environment computer processing systems will typically be server systems, though again may be any appropriate computer processing systems.

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that different types of computer processing systems may have different hardware and architectures than the hardware and architecture that is depicted and described in the present example.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, the connection between the device and system 200 may be via wired or wireless hardware and communication protocols, and may be a direct or an indirect (e.g. networked) connection.

Generally speaking, and depending on the particular system in question, devices to which system 200 connects include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

As another example, where system 200 is a server computing device it may be remotely operable from another computing device via a communication network. Such a server may not itself need/require further peripherals such as a display, keyboard, cursor control device etc. (though may nonetheless be connectable to such devices via appropriate ports).

System 200 also includes one or more communications interfaces 216 for communication with a network, such as network 140 of environment 100. Via the communications interface(s) 140, system 200 can communicate data to and receive data from networked systems and/or devices.

System 200 stores or has access to computer applications (which may also be referred to as computer software or computer programs). Generally speaking, such applications include computer readable instructions and data which, when executed by the processing unit 202, configure system 200 to receive, process, and output data. Instructions and data can be stored on non-transitory machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server system 102 includes one or more systems which run a builder application 104, a hosing application 106, and a data storage application 108. Similarly, developer client system 110 runs a developer client application 112 and viewer client system 120 runs a viewer client application 122.

In some cases part or all of a given computer-implemented method will be performed by system 200 itself, while in other cases processing may be performed by other devices in data communication with system 200.

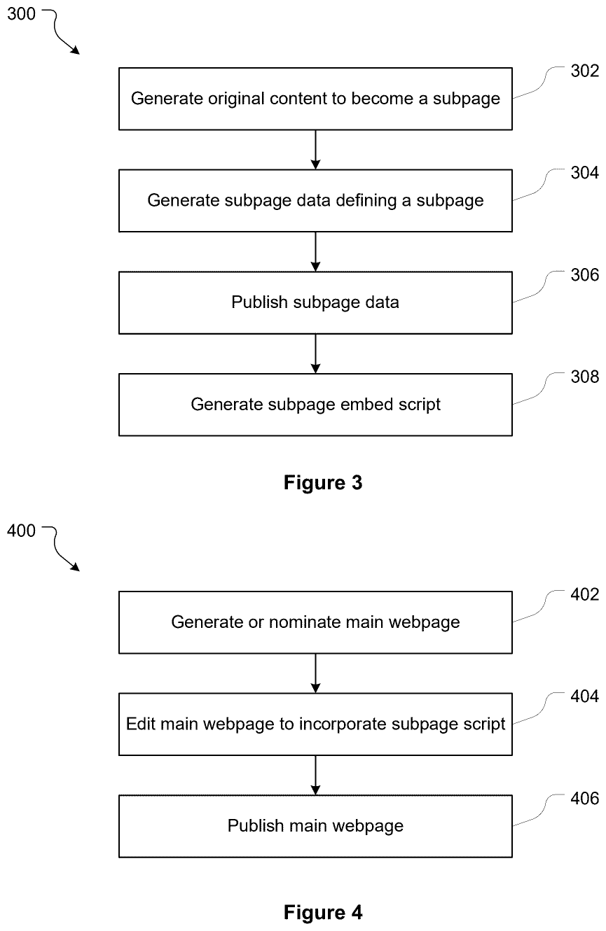

Turning to FIG. 3, a computer-implemented method 300 for generating what will be referred to as a subpage will be described. In the present disclosure, a subpage is a webpage (e.g. html and associated data) that is intended to be to be incorporated into another webpage (which will be referred to herein as the main page).

The operations of method 300 will be described as being performed collectively by the developer application 112 running on the developer system 110 and the builder application 104 running on the server system 102. In alternative embodiments, however, the processing described may be performed by one or more alternative applications running on the client system 110, server system 102, and/or other computer processing systems.

At 302, a user generates original content that will later be transformed to become a subpage. A user may, for example, use developer application 112 and the services provided by the builder application 104 to generate such original content. In the present embodiments, the original content includes one or more backgrounds, each of which is associated with one or more foreground objects. The data associated with original content may be stored at the server system 102 via data storage application 108.

In the present embodiments, an original content background is a visual object (such as an image, graphic, text, video, or other visual object). An original content background may be the visual object alone, but may be a particular state of that visual object. For example a background object may be associated with state data that defines a particular state of the background's visual object—for example a particular zoom level, a particular crop, a particular pan, or an alternative state.

In the present embodiments, an original content foreground object is also a visual object (e.g. a graphic, image, video, text, or other visual object).

In order to illustrate the features of the present disclosure, embodiments are described in which backgrounds are distinct image objects (for example raster or other images) and foreground objects are text objects. Other types of backgrounds and/or foreground objects are, however, possible.

As one example, the original content generated at 302 may be generated as a slideshow or presentation type document. In this case, each slide will have a background and a text caption that a user adds to/associates with a slide may be a foreground object. For example, the original content may be slideshow that includes: a first slide with a background that is the entirety of a map image and a foreground object that is a text caption with text relevant to that map image; a second slide includes a particular zoom of the first slide's map image and a second foreground object that is a text caption with text relevant to that particular zoom; a third slide includes a different image—e.g. a graph or other image—and a third foreground object that is a text caption with text relevant to that graph; and so forth.

As another example, developer application 112 may provide a user interface that allows a user to select backgrounds (e.g. particular visual objects and states thereof) and to then select one or more foreground objects to be associated with each background. Furthermore, developer application 112 may provide a user with tools to create backgrounds and/or foreground objects (e.g. by selecting and editing existing objects or by drawing/creating objects from scratch).

Developer application 112 may facilitate (alone or in conjunction with builder application 104) the generation of original content in any appropriate way. For example, developer application 112 may be a design or word-processing tool (or provide a front end to such a tool) that provides a user with the ability to: create design pages (e.g. slides); create backgrounds for those pages (e.g. by adding one or more design elements to those pages and/or defining particular background states); and associate one or more foreground objects (such as text captions or other foreground objects) with each page.

At 304, the builder application 104 processes the original content to generate subpage data defining a subpage. A subpage may be a webpage or a partial webpage and may be generated by the builder application 104 in various ways.

In the present example, builder application 104 is configured to initially generate an empty webpage (e.g. by use of structural HTML tags such as <html>, <body>, </body>, and </html>) and then add background items and foreground items (that are generated based on the original content) to the webpage.

In order to generate background items, builder application 104 processes the original content and, for each background in the original content, generates a corresponding background item. The background items are then added to the subpage data.

Background items are visible elements of a webpage. Background items may be HTML elements (e.g., an <img> tag corresponding to a background that is an image (or a particular state of an image)). If an original content background is comprised of multiple design elements (e.g. it is a slide or page that includes a background that is made up of a number of images and/or other design elements), application 104 may generate a single corresponding background item by, for example, rasterising the original background design elements. Alternatively, application 104 may generate a set of nested HTML elements that represent the multiple original content design elements that make up the more complex background object.

In the present embodiment, each background item is added to (or as) an independently addressable section of the subpage. This can be achieved in various ways, however, generally involve associating each background item with a unique identifier that (in the present example) both permits identification of the background item and is used to define the order of the background items in the subpage. By way of example, each background item may be added to the subpage in its own <div> or <section> section of the page and be identified via an id attribute of the <div> or <section>. Using this method, a specific background item can be directly referenced by appending a hash after a URL referring to the subpage. For example, to associate a background item with identifier “slide-1”, the background item may be placed within a pair of <div id=“slide-1”> . . . </div> tags and, thereafter, the background item may be directly referenced by, for example, the URL: https://webserver.com/index.html #slide-1. As an alternative example, each background item may be placed within a pair of <section id=“slide-1”> . . . </section> tags.

In order to generate foreground items, application 104 processes the original content and, for each foreground object, generates a corresponding foreground item. The foreground items are then added to the subpage data.

Foreground items are not intended to be directly rendered (and, therefore, result in visible content being displayed) by a web browser (such as a viewer client 122). Rather, each foreground item includes data that is used to automatically generate a foreground element (e.g. a HTML element that can be rendered) and add that foreground element to a main webpage. Accordingly, foreground items are created using techniques which enable including data in a webpage which is not displayed during normal rendering of the webpage but is accessible for processing (e.g., by scripts at runtime).

In the present embodiment, each foreground item is created by processing a foreground object to generate JavaScript Object Notation (JSON) format data that is then included in the subpage data. For example, a text box type foreground object may be transformed into a corresponding JSON representation by presenting the textual content associated with the text box in JSON format. It will be appreciated that other types of data may be included in such JSON representations (e.g., format attributes associated with the text content of the text box). It will also be appreciated that other types of foreground objects (e.g., image, video) may be represented in JSON format. Such JSON representations may, for example, be added to the webpage created earlier within a <script> tag inside the <head> part of the webpage.

In other embodiments, other techniques may be used to include foreground items in subpage data stores that do not result in them being rendered as part of the subpage. Some of such techniques include using custom “data-*” attributes, hidden form elements, <meta> tags, and JavaScript variables or objects. Such data stores can be processed by appropriate JavaScript generate JS objects and pass those objects to the main webpage by postMessage.

Each foreground item is associated with a unique identifier through a method similar or different to that described earlier in relation to association of identifiers to background elements.

In the present embodiment, when generating the subpage data application 104 also generates what will be referred to as display logic data. The display logic data captures (and represents) associations between the background items and the foreground items (and, in due course, the foreground elements that are generated based on the foreground items). In particular, the display logic data provides display rules which operate in conjunction with a movement tracking mechanism (described below with reference to 518 of method 500) to cause particular background items to be displayed when certain conditions are satisfied.

In the present embodiments, and generally speaking, each display rule is associated with a specific background item, a specific foreground item (or a foreground element that will be generated based on that foreground item), and a display condition. The display condition is the condition under which the background item will be displayed, and in the present embodiment is a condition that is based on a position of the foreground element (that is generated based on the foreground item) relative to a viewport that the webpage is displayed in and/or a particular background item.

By way of example, in certain embodiments there is a one-to-one relationship between a foreground element and a background item and the display logic operates such that when a particular foreground element enters the viewport, the background item associated with that foreground element (e.g. an image or other visual element) is displayed. In this case, the background item that is displayed at any given time will be determined based on the foreground element that most recently entered the viewport.

Alternative display logic is, however, possible. For example, a display rule may define that a particular background item is to be displayed when a particular foreground element is either: scrolled into view (i.e. into the viewport); scrolled out of view (i.e. out of the viewport); or scrolled into an alternative position relative to the viewport or the displayed background item.

Application 104 is configured to generate the display logic data based on the original content—for example based on which foreground objects(s) of the original content are associated with which background objects. In the present example Application 104 then adds the display logic data to the subpage data.

The display logic data may take a variety of formats and be included in the subpage using a variety of methods. In some embodiments, the display logic data (or processing rules based thereon) is embedded in HTML/JavaScript code included in the subpage in the form of code responsive to one or more events. In other embodiments, other methods of representing the display logic data may be used (e.g., including as data items in JSON format that may be used later by script codes).

At 306, the builder application 104 publishes the subpage data such that it is accessible to be retrieved by a client application such as viewer application 122. Such publishing may be done, for example, by storing the subpage data in the data store 108 and enabling access to the subpage data through the hosting application 106 (e.g., a web server) through a standard protocol for web-based communication (e.g., HTTP or HTTPS) and a Unique Resource Locator (URL).

At 308, the builder application 104 generates a script that is associated with (and references, e.g. via URL) the published subpage data. This will be referred to as the subpage script. In the present embodiment, the subpage script is an HTML <script> element that includes HTML/JavaScript that is to be embedded (or otherwise incorporated in) another webpage (e.g. a main webpage as described below in relation to method 400).

Generally speaking, and as described in detail below, the subpage script is generated so that when a webpage that includes the script is rendered subpage data (and, optionally, additional code/data to be executed/processed by a client browser application) are retrieved. A subpage script at least includes means of setting up the environment for execution of the associated subpage data as well as instructions to retrieve and execute such data.

The examples provided to illustrate the present disclosure will be directed to associating a subpage script with a single subpage. A subpage script may, however, be associated with multiple subpages. For example, instead of creating a single subpage from original content at 302, builder application 104 may create a differing subpage for each background item (and make each of these subpages separately retrievable by their URL).

Turning to FIG. 4, a computer-implemented method 400 for generating what will be referred to as a main webpage will be described. In the present disclosure, a main webpage may be any webpage that created to include a subpage (as described above) by incorporating a subpage script.

At 402, a user generates a main webpage or nominates an existing webpage as a main webpage. This may be performed, for example, through the developer application 112 (or any other client application) in cooperation with the builder application 104. The main webpage may be any webpage containing any arbitrary content structured according to the HTML standard. For example, a main webpage may be an empty webpage containing only the basic standard HTML tags (e.g., <html>, <body>, </body>, and </html>). On the other hand, a main webpage may contain substantial content including various types of web elements (e.g., texts, images, videos etc.).

At 404, the main webpage is edited to include a subpage script, for example as generated at 308 described above. This may be performed, for example, through the client application 112 in cooperation with the builder application 104. The editing process may involve the user (or application 112 itself) identifying an appropriate location within the main webpage where the subpage is to be displayed (and, accordingly, where the script is to be incorporated. This will typically be a location within the body of the main webpage. The main webpage is then edited by inserting the content of the subpage script at that location. This may, for example, be a copy and paste operation where the subpage script is copied from one location into the main webpage.

While the examples provided in this disclosure are directed to incorporating one subpage embed script into a main webpage, a user may edit a main webpage to include more than one subpage script (each being associated with a different subpage).

At 406, the builder application 104 publishes main webpage (as edited at 404) such that it is accessible to be retrieved by a client application such as viewer application 122. Such publishing may be done, for example, by storing the main webpage data in the data store 108 and enabling access to the main webpage through the hosting application 106 (e.g., a web server) by a standard protocol for web-based communication (e.g., HTTP or HTTPS) and a Unique Resource Locator (URL).

While generation of a main webpage is described as being performed by developer application 112 and builder application 104, a main webpage may be generated (and a subpage script added thereto) by any suitable webpage authoring software or system.

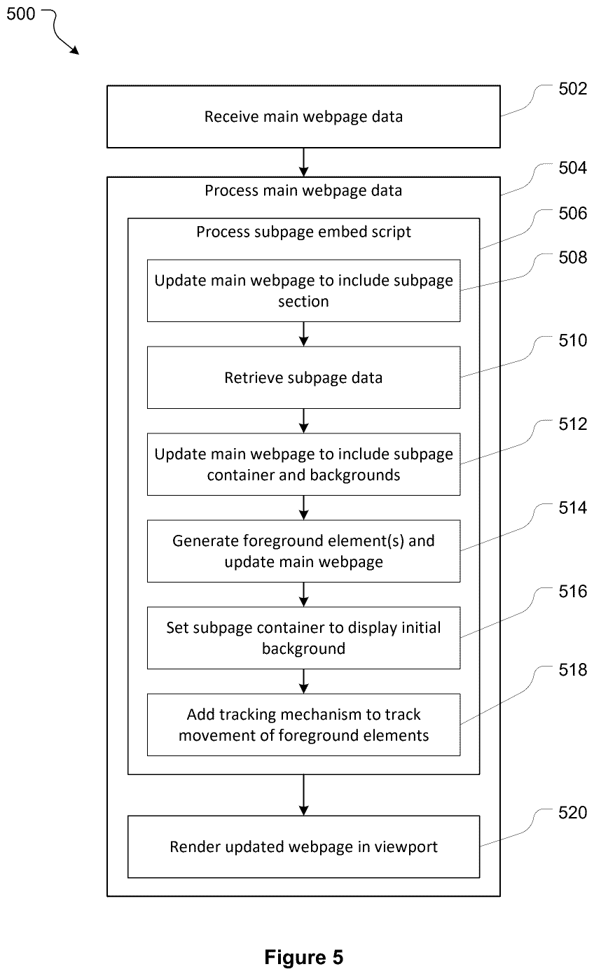

Turning to FIG. 5, a computer-implemented method 500 for retrieving and rendering a main webpage will be described. The operations of method 500 will be described as being performed by the viewer application 122 and the hosting application 106.

At 502, the viewer application 122 retrieves main webpage data from the hosting application 106. This may be performed by, e.g., in response to a user entering the URL of the main page into a search or address bar of a user interface provided by the viewer application 122.

At 504, the viewer application 122 processes the main webpage data. This includes typical processing associated with a webpage and may include rendering one or more main webpage elements in a viewport.

Processing the main webpage data also includes processing the subpage script at 506 (which results the main webpage being updated) which includes the operations of processing blocks 506 and 520.

At 506, the viewer application 122 processes the subpage script that is included in the main webpage. Processing the subpage script causes viewer application 122 to perform a number of operations as described at 508 to 518. If the main webpage includes multiple subpage scripts, each may be processed according to the operations of processing block 506.

At 508, the viewer application 122 updates the main webpage data to include a subpage section.

In the present embodiment, the subpage section provides a grouping mechanism for the webpage elements that are associated with the scroll telling experience that the main page is being updated to provide. In particular, and as described further below, the subpage section of the present embodiments is used to group a subpage container, background items, and foreground elements.

In some embodiments, the subpage section is generated using a <div> HTML tag. Accordingly, the viewer application 122 may modify the main webpage to insert a pair of <div></div> HTML tags at a location specified by the subpage script (which may be the location at which the subpage script is located in the main webpage). In order for such a subpage section to be distinguishable from other subpage sections within the webpage, a unique identifier may be associated with the subpage. For example, the <div> tag may contain an identifier attribute with a pre-defined attribute value.

At 510, the viewer application 122 retrieves subpage data. It will be appreciated that the subpage script may cause application 122 to retrieve subpage data from any source where it is made available. For example, subpage data may be retrieved from the hosting application 106 or any other server hosing subpage data such as a server within a content distribution network (CDN) hosting such data.

At 512, the viewer application 122 generates a subpage container and further updates the main webpage to include the subpage container. The subpage container is included within the subpage section created at 508. The subpage container is created to contain the background items included in the subpage data.

In the present embodiment, the subpage container is generated as an iframe—e.g. using the <iframe> HTML tag. Accordingly, the viewer application 122 may update the main webpage to insert a pair of <iframe></iframe> HTML tags in the subpage section.

Using an iframe as the subpage container provides certain benefits when rendering the main webpage. For example, an iframe provides a sandboxed environment within the main webpage with controlled access to resources and, therefore, provides for a more secure environment to execute code.

Using an iframe also enables retrieving and executing the subpage within the sandboxed environment. Accordingly, and as is the case in certain embodiments of the present disclosure, if such a subpage contains addressable sections (e.g., using id attribute within separate <div> HTML tags), it is possible to bring a specific section of the subpage into the iframe's view using a URL containing the identifier (e.g., by using https://webserver.com/index.html #slide-1 as the URL to bring the section “slide-1” into view).

In addition to adding the subpage container to the main page, the viewer application 122 also loads the background items included in the subpage data into the subpage container. This may be done, for example, by setting the source (“src”) attribute of the iframe to a URL corresponding to the subpage data. As discussed 1005904070 further below, however, the subpage container is configured to only show one background item at a time.

In order to provide the desired scrollytelling experience, the subpage script causes the subpage container to be generated with certain attributes. In the present embodiment, the subpage script causes the subpage container to be associated with a “style” attribute having an attribute value of “position: sticky”. Applying additional (and/or alternative) attributes is possible. For example, it may be desirable for the subpage container to fill the width of the viewport and, in this case, an attribute value of “width: 100%” may be added to the style attribute. Similarly, it may be desirable for the subpage container to stick (i.e., become fixed in position) when scrolled to a certain height within the viewport and, accordingly, a desirable height value may be added to the style attribute. It will be appreciated that other examples of such attributes are possible.

Additionally, the application 122 may configure the subpage container such that the container does not show any visual elements for page navigation (e.g., so that a scroll bar control is not displayed) and does not respond directly to user inputs associated with page navigation (e.g., to receiving events associated with mouse or keyboard). Such configuration may be applied to a subpage container by, for example, associating attribute “scrolling=‘no’” to the subpage container.

At 514, the viewer application 122 processes the subpage data to generate a foreground element corresponding to each foreground item included in the subpage data. Foreground elements are generated to be visible elements of a webpage and may be standard HTML elements (e.g., containing only textual content) or nested elements representing more complex foreground items (e.g., a combination of <div> tags containing various visual elements).

As described above, in some embodiments the foreground items are stored in JSON format. Accordingly, the application 122 may process the JSON data included within the subpage data to extract the data associated with each foreground item and generate a corresponding foreground element.

In some embodiments, application 122 is configured to generate each foreground element using a uniquely identifiable <div> HTML tag containing the data associated with the corresponding foreground item. Other methods of generating and storing foreground elements are possible. Further, each foreground item may be associated with additional attributes (e.g., unique identifiers, font style etc), which may be applied to the corresponding foreground elements.

The viewer application 122 then further updates the main webpage by inserting the foreground element(s) into the updated webpage. In particular, the foreground elements are inserted into the subpage section. For example, the foreground elements are added to the subpage section following (but not in) the subpage container. The order of foreground elements within the subpage may correspond to the order of foreground items stored in the subpage data. The insertion of foreground elements may be done, for example, by injecting the HTML code representing each foreground element (e.g., the <div> HTML tag and associated data) into the updated webpage and within the subpage section.

By inserting the foreground elements into the subpage section and not into the subpage container, the foreground elements become part of the main webpage as updated (and not part of the subpage container). Accordingly, it becomes possible for the viewer application 122 to directly determine the positioning of the subpage container as well as the foreground elements in a viewport together with the positioning of other parts of the updated webpage. This is in contrast with, and provides an improved user experience to, an approach that involves including foreground elements within the subpage container (e.g., an iframe).

At 516, the viewer application 122 sets the subpage container (e.g. the iframe) to display an initial background item. For example, if the background items represent a set of slide backgrounds as exemplified earlier, the application 122 may direct the subpage container to display the background item corresponding to the first slide by setting the source attribute of the iframe to a unique URL such as: https://webserver.com/index.html #slide-1.

At 518, the viewer application 122 adds a tracking mechanism to the subpage section. The tracking mechanism operates in conjunction with the display logic (described above) to cause a displayed background item to change based on the position (or movement) of a foreground element (e.g. the position of a foreground element relative to the viewport). In the present embodiment, the tracking mechanism and display logic are configured so that when a particular display rule is triggered, a display update message is communicated to the subpage which causes the subpage to display a new background item (as defined by the display rule that has been triggered). In one implementation, the message takes the form of a background item identifier that is a hash on the embedded page iframe URL. This can be advantageous as a URL hash allows information to be passed to an iframe context without triggering the embedded page (e.g. the subpage) to reload. In alternative implementations, however, display update message may take a different form, e.g. a postMessage.

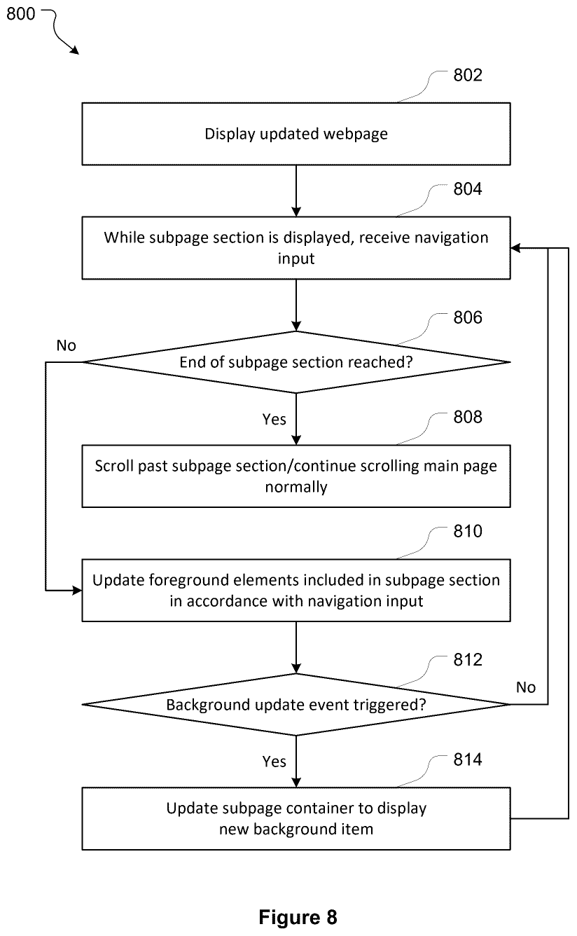

The tracking mechanism itself is created to track the position of the foreground elements within the viewport and in relation to the subpage container. Update events in relation to movements of foreground elements enable the event handler (e.g., the subpage container) to perform specified actions in response thereto. The actions that are performed in response to these events are defined by the display logic data (or by code that is generated and included in the updated main webpage based on that data). Responding to such navigation events is described below in relation to method 800 of FIG. 8.

In some embodiments, the mechanism to track and receive update events about movements of foreground elements is implemented by using “InsersectionObserver” API provided by a web browser. Generally, this API is directed to detecting when an observed element (e.g., a foreground element) enters or exits the viewport or another specific element (e.g., a subpage container). As part of setting up a tracking mechanism with “IntersectionObserver” API, a callback function is nominated which will be executed by the browser whenever the visibility of an observed element (e.g., a foreground element) changes in relation to the viewport or another element (e.g., a background item). This API also provides for configuring thresholds, which may be a single number or an array of numbers, that determine what percentage of change in the observed element's visibility should trigger the callback function.

It will be appreciated that the “IntersectionObserver” API and the corresponding callback function may be placed in different parts of the updated webpage. For example, the code setting up the “InetsectionObserver” API may be included in the main part of the updated webpage whereas the callback function may be included within the subpage container. It will also be appreciated that mechanism of passing messages between different parts of the updated webpage may be required (e.g., a postMessage function to pass messages between the parent webpage and an embedded iframe).

It will also be appreciated that using “IntersectionObserver” API is not the only method through which such a tracking mechanism may be set up by the application 122. Other mechanisms are possible such as configuring a scroll event listener or using third-party code libraries.

At 520, the viewer application 122 renders the updated webpage, or part thereof, in a viewport. This may be performed, e.g., by a web browser displaying the updated webpage in its viewport.

In the examples described above, the embed script includes code that causes a subpage section (e.g. a <div> section) to be added to the main webpage. In alternative embodiments, the subpage section may be added to the page (and the subpage script inserted into the subpage section) at the time the subpage script is added to the main webpage (e.g. at 404 above). In this case, updating the main webpage to include a subpage section at 508 will not be necessary.

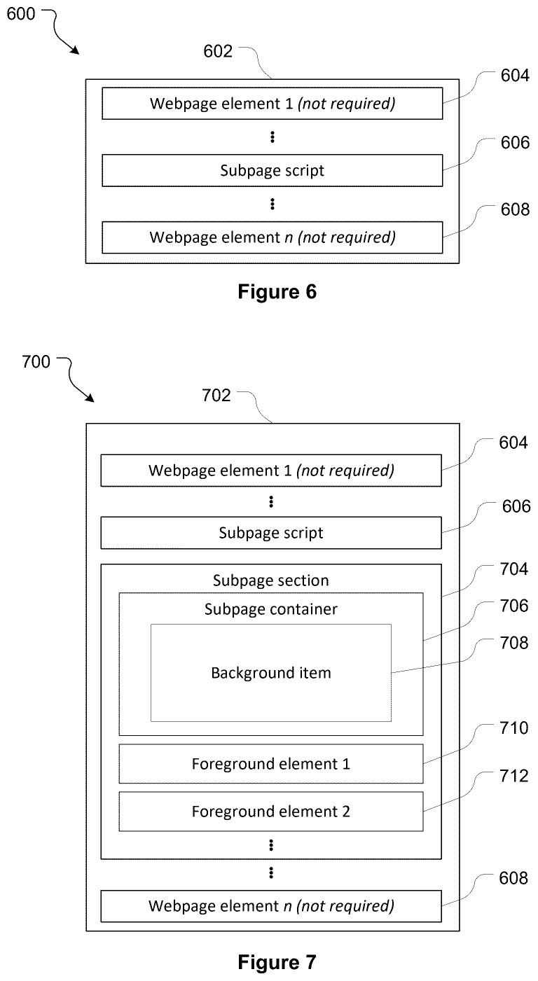

Turning to FIG. 6, a block diagram is presented depicting a logical view 600 of an example main webpage 602 prior to being rendered and updated based on a subpage script.

The main webpage 602 includes a first webpage element 604, a subpage script 606, and a second webpage element 608. The webpage elements 604 and 608 may be any webpage element (e.g., text, image, a <div> section, or multiple nested elements), and the presence of such webpage elements is optional.

The subpage script 606 exemplifies an embed script created according to the method 300 of FIG. 3 which is embedded into the example main webpage 602 according to the method 400 of FIG. 4 as described above.

Turning to FIG. 7, a block diagram is presented depicting a logical view 700 of an example updated webpage 702—that is, a main webpage after it has been updated based on a subpage script.

In this example, the updated webpage 702 is based on the example main webpage 600 and is generated according to the method 500 of FIG. 5. Accordingly, the updated webpage 702 includes the contents of the main webpage 600, namely, the webpage elements 604 and 608 as well as the subpage embed script 606.

The updated webpage 702 additionally includes a subpage section 704, a subpage container 706, a first background item 708, and two foreground elements 710 and 712. These additional elements are created by, e.g., a viewer application 122 at 506 of the method 500 described above.

Turning to FIG. 8, a computer-implemented method 800 for navigating a webpage will be described. The operations of method 800 will be described as being performed by the viewer application 122 running on the viewer system 122.

At 802, the viewer application 122 displays a webpage in a viewport. The webpage may, for example, be a webpage that includes a subpage script and has been updated according to method 700 described above. Generally, however, the webpage displayed at 802 includes: a subpage section (which may, for example, be a <div> section); a subpage container (which may, for example, be an iframe) that is located in the subpage section, is loaded with a set of background items, and is configured to initially display a first background item of that set of background items; one or more foreground elements that are located in the subpage section (but not in the subpage container); a mechanism to track and receive update events about movements of foreground elements and, based on display rules, to update background items that are displayed based on foreground element positions.

At 804, the client application 122 receives navigation input from a user while a subpage section is in the viewport (and, therefore, visible on display). Such navigation input may, for example, be a scrolling input that is received via, a touchscreen 218, cursor control device 224, keyboard 226, or other input device associated with the viewer system 120.

At 806, the viewer application 122 determines whether the end of the subpage section has been reached. The end of a subpage section may be reached, for example, as the result of the last element included in the subpage section (e.g., the foreground element 712 in the updated webpage 702) being scrolled out of the viewport.

If it is determined that the end of the subpage section has been reached, control proceeds to 808. At 808, and assuming there is further webpage content following the end of the subpage section, the viewer application 122 continues scrolling the webpage normally. This will typically result in the subpage section being moved, partially or completely, out of the viewport.

On the other hand, if it is determined at 806 that the end of the subpage section has not been reached, control proceeds to 810, At 810, viewer application 122 scrolls within the subpage section. This will result in the foreground elements included in the subpage section being moved in accordance with the navigation input. Movement of the foreground elements may result in a currently displayed foreground element being moved within or out of the viewport. Movement of the foreground elements may also result in a new (previously un-displayed) foreground element being moved into the viewport. Where a foreground element is displayed in the viewport it may for example be displayed on top of the currently displayed background item (e.g. so it scrolls over the background item), partially on top of the background item, or beside the background item (e.g. so it scrolls beside the background item without obscuring the background item).

At 812, the client application 122 determines whether a background update event should be triggered based on the display logic. Such an event may be triggered, for example, in response to a foreground element moving relative to the viewport, a background item, or subpage container. The mechanism to monitor and receive such movements is described above at 518 of FIG. 5.

If it is determined that a background update event should not be triggered, control returns to 804 where further navigation inputs are received for processing.

If it is determined that a background update event should be triggered at 812, control continues to 814 where the client application 122 responds to such an event by updating the subpage container to display a new background item. This update is performed based on the display rules described above. In the present embodiments, the update is performed by causing the iframe (i.e., the subpage container) to display a different background in accordance with the display rule that has been triggered. This, in turn, is achieved by setting the subpage container's URL to the URL associated with the relevant background item. For example, assuming that background items correspond to a number of slides in a slideshow and that presently the first slide is displayed within the iframe, updating the background item to a second element may involve setting the URL associated with the iframe to, e.g., https://webserver.com/index.html #slide-2.

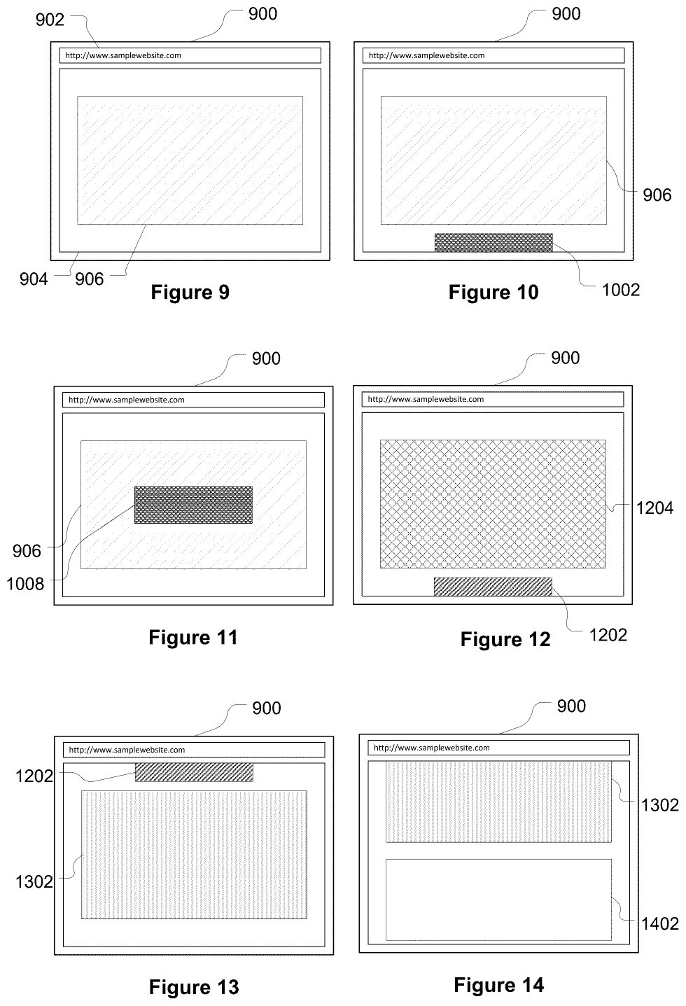

Turning to FIGS. 9-13, block diagrams are presented depicting an example user interface (UI) 900 that is displayed by a viewer application 122. UI 900 corresponds to a typical web browser application with an address bar control 902 and a viewport 904.

FIG. 9 depicts an initial view where a background item 906 is displayed within the viewport 904. Background item 906 may, for example, be an image (and may be defined by an <img> HTML tag).

Continuing the example to FIG. 10, while background item 906 is visible, the viewer application 122 receives user navigation input that scrolls down through the webpage that is displayed. In response, the viewer application 122 moves a foreground element 1002 partially into the viewport 904. In this example, the viewer application 122 determines that no background update event should be triggered at this stage.

Continuing the example to FIG. 11, the viewer application 122 receives further user navigation input scrolling down the webpage and, in response, moves the foreground element 1002 to the middle of the viewport and the background item. In this example also, the viewer application 122 determines that no background update event should be triggered at this stage.

Continuing the example to FIG. 12, the viewer application 122 receives further user navigation input scrolling down the webpage and, in response, moves the foreground element 1002 out of the viewport 904 in its entirety. The user navigation input further causes a new foreground element 1202 to scroll partially into view (i.e. into the viewport 904). In this example, the viewer application 122 determines that a background update event should be triggered. In particular, the event is triggered in response to detecting that foreground element 1202 has moved into the viewport 904. In response to the event, and based on a display rule that defines that when foreground element 1202 is moved into the viewport background 1204 should be displayed, the subpage container is updated to display new background item 1204 (instead of previous background item 906). New background item 1204 may be a particular state of the same image used in background item 906 (e.g. a particular pan/zoom) or may be a different image to that of background item 906.

Continuing the example to FIG. 13, the viewer application 122 receives further user navigation input scrolling down the webpage and, in response, moves the foreground element 1202 partially off the viewport 904. In this example, the viewer application 122 determines that a background update event should be triggered. In particular, the event is triggered in response to detecting that foreground element 1202 has moved partially out of the viewport). In response to the event, and based on a display rule that defines that when foreground element 1202 is moved partially out of the viewport background 1302 should be displayed, the subpage container is updated to display background item 1302 (instead of background item 1204).

Continuing the example to FIG. 14, the viewer application 122 receives further user navigation input scrolling down the webpage. In this instance, the navigation input scrolls past the final foreground element and, accordingly, the viewer application 122 starts scrolling the entire subpage section (which, in this example, is still displaying background item 1302) out of the viewport 904. As the subpage section is scrolled out of the viewport 904, other original elements of the main webpage (e.g. element 1402) are scrolled into view.

The following first set of numbered clauses describe additional, specific embodiments of the disclosure:

Clause 1. A computer implemented method including:
receiving main webpage data defining a main webpage, wherein the main webpage data includes a subpage script;
processing the subpage script, wherein processing the subpage script includes:
   retrieving subpage data that defines a first background item, a second background item, a first foreground item, and a second foreground item;
   updating the main webpage to include a subpage container, wherein the subpage container is included in a subpage section of the main webpage;
   including the first background item and the second background item in the subpage container;
   generating, based on the first and second foreground items, first and second foreground elements;
   updating the main webpage so that the first and second foreground elements are included in the subpage section but not the subpage container; and
updating the main webpage to include a tracking mechanism that is configured to track movement of the first and second foreground elements; and
displaying the main webpage on a display.

Clause 2. The computer implemented method of clause 1, further including:
displaying the first background item;
receiving a first user navigation input that causes the first foreground element to move relative to the first background item; and
determining that a first display rule is triggered based on the movement of the first foreground element; and
in response to determining that first display rule is triggered, displaying the second background item.

Clause 3. The computer implemented method of clause 2, wherein determining that the first display rule is triggered includes determining that the first foreground element is scrolled into a display port that the first background item is displayed in.

Clause 4. The computer implemented method of clause 2, wherein determining that the first display rule is triggered includes determining that the first foreground element is scrolled out of a display port that the first background item is displayed in.

Clause 5. The computer implemented method of any one of clauses 1 to 4, wherein the subpage container is an iframe.

Clause 6. The computer implemented method of any one of clauses 1 to 5, wherein the subpage section is defined by a HTML div tag.

Clause 7. The computer implemented method of clause 6, wherein processing the subpage script further includes updating the main webpage to include the subpage section.

Clause 8. The computer implemented method of any one of clauses 1 to 7, wherein the first background item and the second background item are defined in in separately addressable sections of the subpage data.

Clause 9. The computer implemented method clause 8, wherein the first background item and the second background item are defined in separate HTML <div> sections of the subpage data.

Clause 10. The computer implemented method clause 8, wherein the first background item and the second background item are defined in separate HTML <section> sections of the subpage data.

Clause 11. The computer implemented method of any one of clauses 1 to 10, wherein the first background item is a first image.

Clause 12. The computer implemented method of clause 11, wherein the second background item is a second image.

Clause 13. The computer implemented method of any one of clauses 1 to 10, wherein the first background item is a first state of a first image and the second background item is a second state of the first image.

Clause 14. The computer implemented method of any one of clauses 1 to 13, wherein the first foreground element includes text.

The following second set of numbered clauses describe additional, specific embodiments of the disclosure:

Clause 1. A computer implemented method including:
receiving original content that includes a first background, a second background, a first foreground object that is associated with the first background, and a second foreground object that is associated with the second background;
processing the original content to generate subpage data defining a subpage, wherein processing the original content to generate the subpage data includes:
   generating first and second HTML items corresponding to the first and second backgrounds;
   generating first and second foreground items corresponding to the first and second foreground objects;
   generating a tracking mechanism that is configured to track movement of the first and second foreground elements when they are displayed; and
   generating display logic that includes a first display rule that associates the first background item with a first foreground element that can be generated based on the first foreground item and a second display rule that associates the second background item with a second foreground element that can be generated based on the second foreground item; and
generating a subpage script for inclusion in a main webpage, wherein processing the main webpage that includes the subpage script causes an application displaying the main webpage to:
   retrieve the subpage data;
   update the main webpage to include a subpage container, wherein the subpage container is included in a subpage section of the main webpage;
   include the first background item and the second background item in the subpage container;
   generate the first and second foreground elements based on the first and second foreground items; and
   update the main webpage so that the first and second foreground elements are included in the subpage section but not the subpage container.

Clause 2. The computer implemented method clause 1, wherein the first background item and the second background item are defined in in separately addressable sections of the subpage data.

Clause 3. The computer implemented method clause 2, wherein the first background item and the second background item are defined in separate HTML <div> sections of the subpage data.

Clause 4. The computer implemented method clause 2, wherein the first background item and the second background item are defined in separate HTML <section> sections of the subpage data.

Clause 5. The computer implemented method of any one of clauses 1 to 4, wherein the first background item is a first image.

Clause 6. The computer implemented method of clause 5, wherein the second background item is a particular state of the first image.

Clause 7. The computer implemented method of clause 5, wherein the second background item is a second image.

Clause 8. The computer implemented method of any one of clauses 1 to 7, wherein the first and second foreground items are each defined by JavaScript Object Notation (JSON) data.

Clause 9. The computer implemented method of any one of clauses 1 to 8, wherein the subpage script is defined using a HTML <script> tag.

Additional, specific embodiments of the disclosure include a computer processing system including:
a processing unit; and
non-transitory computer-readable media storing instructions which, when executed by the processing unit, cause the processing unit to perform: a method according to any of any one of clauses 1 to 14 of the first clause set; and/or a method according to any of any one clauses 1 to 9 of the second clause set.

Additional, specific embodiments of the disclosure include non-transitory computer readable media storing instructions executable by a computer processing unit to cause the computer processing unit to perform: a method according to any of any one clauses 1 to 14 of the first clause set; and/or a method according to any of any one of clauses 1 to 9 of the second clause set.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, operations, steps, or elements.

Unless required by context, the terms “first”, “second”, etc. are used to differentiate between various elements and features and not in an ordinal sense. For example, a first feature could be termed a second feature, and, similarly, a second feature could be termed a feature, without departing from the scope of the described examples.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer implemented method including:
receiving main webpage data defining a main webpage, wherein the main webpage data includes a subpage script;
processing the subpage script, wherein processing the subpage script includes:
retrieving subpage data that defines a first background item, a second background item, a first foreground item, and a second foreground item;
updating the main webpage to include a subpage container, wherein the subpage container is included in a subpage section of the main webpage;
including the first background item and the second background item in the subpage container;
generating, based on the first and second foreground items, first and second foreground elements;
updating the main webpage so that the first and second foreground elements are included in the subpage section but not the subpage container; and
updating the main webpage to include a tracking mechanism that is configured to track movement of the first and second foreground elements; and
displaying the main webpage on a display.

2. The computer implemented method of claim 1, further including:
displaying the first background item;
receiving a first user navigation input that causes the first foreground element to move relative to the first background item; and
determining that a first display rule is triggered based on the movement of the first foreground element; and
in response to determining that first display rule is triggered, displaying the second background item.

3. The computer implemented method of claim 2, wherein determining that the first display rule is triggered includes determining that the first foreground element is scrolled into a display port that the first background item is displayed in.

4. The computer implemented method of claim 2, wherein determining that the first display rule is triggered includes determining that the first foreground element is scrolled out of a display port that the first background item is displayed in.

5. The computer implemented method of claim 1, wherein the subpage container is an iframe.

6. The computer implemented method of claim 1, wherein the subpage section is defined by a HTML div tag.

7. The computer implemented method of claim 6, wherein processing the subpage script further includes updating the main webpage to include the subpage section.

8. The computer implemented method of claim 1, wherein the first background item and the second background item are defined in in separately addressable sections of the subpage data.

9. The computer implemented method of claim 8, wherein the first background item and the second background item are defined in separate HTML <div> sections of the subpage data.

10. The computer implemented method of claim 8, wherein the first background item and the second background item are defined in separate HTML <section> sections of the subpage data.

11. The computer implemented method of claim 1, wherein the first background item is a first image.

12. The computer implemented method of claim 11, wherein the second background item is a second image.

13. The computer implemented method of claim 1, wherein the first background item is a first state of a first image and the second background item is a second state of the first image.

14. The computer implemented method of claim 1, wherein the first foreground element includes text.

15. A computer processing system including:
one or more processing units;
a display; and
non-transitory computer-readable media storing instructions which, when executed by the one or more processing units, cause the one or more processing units to perform a method including:
receiving main webpage data defining a main webpage, wherein the main webpage data includes a subpage script;
processing the subpage script, wherein processing the subpage script includes:
retrieving subpage data that defines a first background item, a second background item, a first foreground item, a\grave{ }nd a second foreground item;
updating the main webpage to include a subpage container, wherein the subpage container is included in a subpage section of the main webpage;
including the first background item and the second background item in the subpage container;
generating, based on the first and second foreground items, first and second foreground elements;
updating the main webpage so that the first and second foreground elements are included in the subpage section but not the subpage container; and
updating the main webpage to include a tracking mechanism that is configured to track movement of the first and second foreground elements; and
displaying the main webpage on a display.

16. The computer processing system of claim 15, wherein the method further includes:
displaying the first background item;
receiving a first user navigation input that causes the first foreground element to move relative to the first background item; and
determining that a first display rule is triggered based on the movement of the first foreground element; and
in response to determining that first display rule is triggered, displaying the second background item.

17. The computer processing system of claim 16, wherein determining that the first display rule is triggered includes determining that the first foreground element is scrolled into a display port that the first background item is displayed in.

18. Non-transitory computer readable media storing instructions executable by one or more computer processing units to cause the one or more computer processing units to perform a method including:
processing the subpage script, wherein processing the subpage script includes:
retrieving subpage data that defines a first background item, a second background item, a first foreground item, and a second foreground item;
updating the main webpage to include a subpage container, wherein the subpage container is included in a subpage section of the main webpage;
including the first background item and the second background item in the subpage container;
generating, based on the first and second foreground items, first and second foreground elements;
updating the main webpage so that the first and second foreground elements are included in the subpage section but not the subpage container; and
updating the main webpage to include a tracking mechanism that is configured to track movement of the first and second foreground elements; and
displaying the main webpage on a display.

19. The non-transitory computer readable media of claim 18, wherein the method further includes:
displaying the first background item;
receiving a first user navigation input that causes the first foreground element to move relative to the first background item; and
determining that a first display rule is triggered based on the movement of the first foreground element; and
in response to determining that first display rule is triggered, displaying the second background item.

20. The non-transitory computer readable media of claim 19, wherein determining that the first display rule is triggered includes determining that the first foreground element is scrolled out of a display port that the first background item is displayed in.
